(19) United States
(12) Patent Application Publication
(10) Pub. No.: US 2011/0145014 A1
(43) Pub. Date: Jun. 16, 2011

(54) INTERNATIONAL LIFE-SAVING RAPID RETRIEVING TOOL

(76) Inventor: Suzette Jacqueline Avneri, Hawthorne, FL (US)

(21) Appl. No.: 12/964,279

(22) Filed: Dec. 9, 2010

Related U.S. Application Data
(60) Provisional application No. 61/286,747, filed on Dec. 15, 2009.

(51) Int. Cl. G06Q 50/00; G06Q 10/00

(52) U.S. Cl. 705/3

(57) ABSTRACT

A method for maintaining medical records online, with the nursing perspective, comprises of receiving medical records and converting the data to electronic form from any format received. Login information is received by a reviewer for allowing review of the medical records. The reviewed and un-reviewed medical records are securely stored for the rapid retrieval of data needed in emergent and standard healthcare situations, thereby saving lives internationally. This tool can be used for all living and/or inanimate entities on the planet.

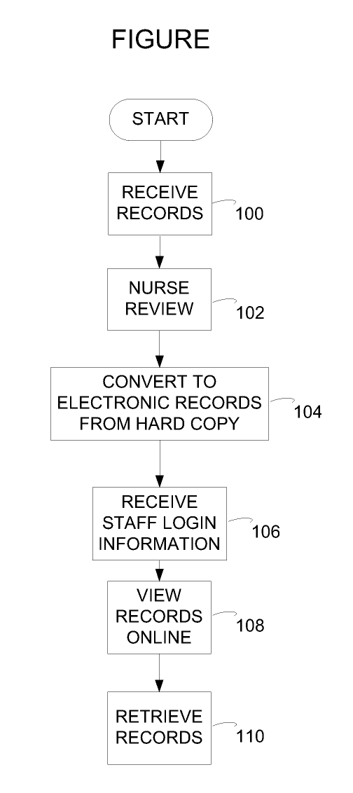

### RELATED APPLICATION INFORMATION

This Application is a non-provisional of Application Ser. No. 61/286,747, entitled “Confidential-Electronic-Nursing Healthcare Records Reviews—Paper Health Records Electronic Conversions -Electronic Health Records Storage”, filed Dec. 15, 2009.

### BACKGROUND OF THE INVENTION

The present invention generally relates to a unique tool administrated with the nursing perspective. More specifically, the invention relates to a system and to a method for online storage, review, and rapid retrieval of medical records in both emergent and standard healthcare situations on an international basis.

Many methods of providing accurate and secured online medical records have been tried but have failed; this tool will resolve this.

Thus, there is a need for an accurate, rapid, and secure online medical records system to provide for saving lives on an international basis.

### SUMMARY OF THE INVENTION

In one aspect of the present invention, a method for maintaining medical records online comprises: receiving medical records, converting the medical records to electronic form, receiving login information for a reviewer, allowing review of the medical records by the reviewer, storing and rapid retrieval of the reviewed and un-reviewed medical records as specified in this document.

These and other features, aspects and advantages of the present invention will become better understood with reference to the following drawings, description and claims;

### BRIEF DESCRIPTION OF THE DRAWINGS

The Figure is a flow diagram illustrating the steps of one embodiment of the invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide an on-line rapid retrievable medical records system with the nursing perspective.

With reference to the Figure, a flow diagram illustrates the steps performed in a medical records system according to one embodiment. In a networked system, one step 100 may be to receive medical records (or any other data, such as veterinary medicine records, aquatic records, or any records related to animals, plants, zoological studies, horticulture, or the like). The records can be received in any format. A confidential nursing review can take place at step 102.

In step 104, the data can be converted to electronic records from hard copy, if necessary, by scanning, while simultaneously encrypting into the online system. Any hard copy disc data or medium received can be loaded into a compatible online system. Electronic data can also be received via encrypted electronic means. By way of example, and not by way of limitation; data can be received by e-mail, facsimile, or the like.

In step 106, login information can be received by the system for staff, nursing, administrative, consultative or other staff, requiring access to medical records to perform assigned work.

In step 108, the system will allow online reviewing of the records. Information will be accessed by a rapid retrieval tool for review by nursing staff, or appropriate consultative staff for data related or unrelated to humans as required by any entity internationally. All healthcare or medical records can be reviewed by nursing, administrative or other consultative records review staff for potential deficiencies. Screenings can include, by way of example, and not by way of limitation: billing, coding, utilization and quality of the overall information provided.

In step 110, rapid secure retrieval of the records can be allowed. Each entity will be offered different ways of setting up the rapid secure retrieval, internationally, such as a client's personal healthcare information. The client will be allowed to inform the system of the language in which the records are displayed. A language software conversion tool or other modality will then be used to display in the selected language. The methods of retrieval will include, by way of example, and not by way of limitation: encrypted universal product code (UPC) barcode, fob, internet link, unique encrypted ID and pass codes, radiofrequency UPC barcode scanner and microchip, ID card with unique UPC barcode, telephone, or fax (when no other higher -secured method is available).

Some of the above-stated methods of secure rapid retrieval of data are described in more detail as follows:
1) Encrypted UPC Barcode & Fob: It will be convenient for those who, by way of example and not by way of limitation: travel frequently (or for other reasons) who do not want to be burdened by remembering pass codes, and /or who have chronic or sudden illness rendering them unresponsive or unable to answer questions at the time of any service related to healthcare, to use this method. Each patient or client may retain their own tangible security fob, which can be worn as a necklace, bracelet, on a key chain or most any other object for this method. Each fob will contain a unique encrypted security code that would be swiped across a UPC scanner to link up with the rapid, secure system servers. For this method, UPC or other modality scanners may be necessary at: ambulance services, emergency rooms, hospitals, healthcare provider's offices, laboratories, diagnostic centers or any provider entities related to healthcare to retrieve information worldwide.
2) Internet Link Unique Encrypted ID and Pass codes: Each client or patient will be given their own unique encrypted user ID and pass code with a secure link to their health information located on the rapid secure server system. Additional security questions may be required.
3) Radio Frequency UPC Barcode scanner & Micro-Chip: This method does have some similarities to the encrypted barcode & fob methods described above. A microchip with an encrypted UPC that can be picked up by radio frequency emissions to a rapid secure linkup with the secure server system can be provided. The micro-chips can be placed in almost any object, such as a piece of jewelry, or even subcutaneously.
4) ID card with Unique UPC Barcode: A plastic ID card with unique encrypted UPC will be provided to the entity or patient, which can be swiped through an electronic card reader to securely link with the rapid secure server system.
5) Telephone: When no other method is available, phone representatives are available 24 hours a day, 7 days a week to assist securely over the phone. A series of security questions unique to the entity will be asked at the time of the call for verification.

Additionally, in one embodiment, during the review process, nursing staff may work alongside the following: review agencies, government agencies related to healthcare, managed healthcare organizations, health insurance companies, hospitals or any entity related. Therefore, any entity that uses this system must have review business licensure and have physician advisors/medical directors who make final determinations. Reviews completed by nursing staff serve as nursing recommendations only.

Another embodiment, the HIPPA Act will be adhered to. However, any entity will be responsible for the safekeeping of the FOB, Micro-chip, ID Card or any device in his or her possession that provides access to stored records. Additionally, in one embodiment, nursing reviews can be performed at any given point of the process, or as a completely separate service, depending on user's need and staffing availability.

It should be understood, of course, that the foregoing relates to exemplary embodiments of the invention and that modifications may be made without departing from the spirit and scope of the invention as set forth in the following claims.

1. A method for maintaining medical records online, comprising:
receiving medical records;
converting the medical records to electronic form;
receiving login information for a reviewer;
allowing review of the medical records by the reviewer; and
storing the reviewed medical records.

2. The method of claim 1, further comprising allowing rapid retrieval of the reviewed and un-reviewed medical records

3. The method of claim 2, wherein the rapid retrieval of the reviewed and un-reviewed medical records is secured.

4. The method of claim 3, wherein the rapid retrieval is secured by means of a code that is read by a security system.

5. The method of claim 4, wherein the security system uses encryption.

6. The method of claim 4, wherein the security system uses a scanner to scan the code.

7. A method for maintaining administrative records online, comprising:
receiving records;
converting the records to electronic form;
receiving login information for a reviewer;
allowing review of the records by the reviewer; and
storing the reviewed records.

8. The method of claim 7, further comprising allowing rapid retrieval of the reviewed and un-reviewed records.

9. The method of claim 8, wherein the rapid retrieval of the reviewed records is secured.

10. The method of claim 9, wherein the rapid retrieval is secured by means of a code that is read by a security system.
